(19) United States
(12) Patent Application Publication
(10) Pub. No.: US 2021/0347968 A1
(43) Pub. Date: Nov. 11, 2021

(54) SOLID CROSSLINKED POLYOLEFIN COMPOSITIONS FOR WIRE AND CABLE COATING

(71) Applicant: Dow Global Technologies LLC, Midland, MI (US)

(72) Inventors: Paul J. Brigandi, Schwenksville, PA (US); Kurt A. Bolz, Allentown, NJ (US); Mohamed Esseghir, Lawrenceville, NJ (US); Madelaine E. Saunders, Collegeville, PA (US)

(21) Appl. No.: 17/274,727

(22) PCT Filed: Dec. 6, 2019
(86) PCT No.: PCT/US2019/064845

§ 371 Date: Mar. 9, 2021

Related U.S. Application Data
(60) Provisional application No. 62/785,302, filed on Dec. 27, 2018.

(51) Int. Cl. C08L 23/06; H01B 3/44

(52) U.S. Cl. CPC C08L 23/06; H01B 3/441; C08L 2203/202; C08L 2205/025; C08L 2207/066; C08L 2312/08; C08L 2207/062

(57) ABSTRACT

The present disclosure provides a composition. In an embodiment, a crosslinked polymeric composition is provided and comprises (A) from 4 wt % to 45 wt % of a thermoplastic polymer, (B) from 52 wt % to 95 wt % of a moisture-curable polyolefin, and (C) from 0.05 wt % to 7 wt % of a moisture condensation catalyst. The present disclosure provides an article. In an embodiment, a coated conductor is provided and comprises a conductor, and a coating on the conductor. The coating comprises a crosslinked polymeric composition comprising (A) from 4 wt % to 45 wt % of a thermoplastic polymer, (B) from 52 wt % to 95 wt % of a moisture-curable polyolefin, and (C) from 0.05 wt % to 7 wt % of a moisture condensation catalyst.

### BACKGROUND

Improving rheological or melt flow properties of polyolefin resins is important for wire and cable applications to meet increasing demand for improved processability for various cable constructions. Continuing trends in twisted-pair category data cables require increased use of a low voltage signal to power devices through the data cable (Power over Ethernet or PoE), which results in higher operating temperatures of the cable. The potential for softening of the cable insulation caused by the higher temperatures raises concern whether thermoplastic solid or foamed insulations can withstand compressive stresses over the cable's several decade lifespan. For example, temperature limitations of conventional thermoplastic materials limit PoE category data cable applications to about 100 Watts. Crosslinked solid (non-foamed) or foamed insulations may provide a better alternative for PoE category data cable applications.

Moisture-curable polyolefins possess the flexibility required of an insulative material for wire and cable but can have narrow molecular weight distributions (MWD). Many moisture-curable polyolefins exhibit a viscosity profile which leads to limited processability (e.g., the onset of melt fracture), and poor surface smoothness at extrusion line speeds above 300 meters per minute.

A need exists for moisture-curable polyolefin compositions having good processability (i.e., little, or no, melt fracture) and adequate tensile strength, elongation, high temperature resistance, and hot creep properties suitable for wire and cable application.

### SUMMARY

The inventors discovered that higher melting point solid polymers (e.g., broad MWD high density polyethylene) can be blended with moisture-curable polyolefins to produce crosslinked compositions that have high melt strength and high flexibility and also exhibit good processability and surface smoothness in high speed extrusion applications.

The present disclosure provides a crosslinked polymeric composition comprising (A) from 4 wt % to 45 wt % of a thermoplastic polymer, (B) from 52 wt % to 95 wt % of a moisture-curable polyolefin, and (C) from 0.05 wt % to 7 wt % of a moisture condensation catalyst.

The present disclosure also provides a coated conductor comprising a conductor; and a coating on the conductor, the coating comprising a crosslinked polymeric composition comprising, (A) from 4 wt % to 45 wt % of a thermoplastic polymer, (B) from 52 wt % to 95 wt % of a moisture-curable polyolefin, and (C) from 0.05 wt % to 7 wt % of a moisture condensation catalyst.

### Definitions

For purposes of United States patent practice, the contents of any referenced patent, patent application or publication are incorporated by reference in their entirety (or its equivalent U.S. version is so incorporated by reference), especially with respect to the disclosure of definitions (to the extent not inconsistent with any definitions specifically provided in this disclosure) and general knowledge in the art.

The numerical ranges disclosed herein include all values from, and including, the lower and upper value. For ranges containing explicit values (e.g., 1 to 7), any subrange between any two explicit values is included (e.g., 1 to 2; 2 to 6; 5 to 7; 3 to 7; 5 to 6; etc.).

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, (whether polymerized or otherwise), unless stated to the contrary. In contrast, the term, “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

Any reference to the Periodic Table of Elements is that as published by CRC Press, Inc., 1990-1991. Reference to a group of elements in this table is by the new notation for numbering groups.

Unless stated to the contrary, implicit from the context, or customary in the art, all parts and percentages are based on weight and all test methods are current as of the filing date of this disclosure.

“Ambient conditions” and like terms refers to temperature, pressure and humidity of the surrounding area or environment of an article. The ambient conditions of a typical office building or laboratory include a temperature of 23° C. and atmospheric pressure.

“Blend,” “polymer blend” and like terms refer to a combination of two or more polymers. Such a blend may or may not be miscible. Such a combination may or may not be phase separated. Such a combination may or may not contain one or more domain configurations, as determined from transmission electron spectroscopy, light scattering, x-ray scattering, and any other method known in the art.

“Catalytic amount” refers to an amount of catalyst necessary to promote a reaction, e.g., the grafting of a silane compound to a polyolefin, or the crosslinking of an ethylene-vinylsilane polymer, etc., at a detectable level, preferably at a commercially acceptable level.

“Coating” and like terms refers to the application in any manner, e.g., contacting, depositing, “salting out”, precipitating, etc., of one material (i.e., the applied material), to another material (i.e., the base material), such that the applied and base materials adhere to one another. “Coating” also refers to the applied material that has been contacted, or deposited, etc., to the base material. In the context of wire and cable, the coating is typically a polymer that has been extruded over and in contact with a wire or previously coated wire or cable, such as a semiconductor layer, or an insulation layer, or an outer protective jacket.

“Composition” and like terms refers to a mixture or blend of two or more components. For example, in the context of preparing a silane-grafted ethylene polymer, a composition would include at least one ethylene polymer, at least one vinyl silane, and at least one free radical initiator. In the context of preparing a cable sheath or other article of manufacture, a composition would include an ethylene-vinylsilane copolymer, a catalyst cure system and any desired additives such as lubricants, fillers, anti-oxidants and the like.

“Conductor” denotes one or more wire(s) or fiber(s) for simultaneously conducting power (electricity) and data (light). The conductor can be a single wire, a single fiber, a multi-wire, or a multi-fiber and may be in strand form or in tubular form. Non-limiting examples of suitable conductors include metals (e.g., silver, gold, copper, aluminum) and optical fibers made from glass or plastic. The conductor can be used for local area network (LAN)/data or fiber optic cable.

“Crosslink,” as used herein refers to a covalent bond between two or more polymers that are otherwise structurally distinct chemical entities.

“Crosslinkable”, “curable” and like terms refer to a polymer that is not cured or crosslinked and has not been subjected or exposed to treatment that has induced substantial crosslinking although the polymer comprises additive(s) or functionality which will cause or promote substantial crosslinking upon subjection or exposure to such treatment (e.g., exposure to water). The polymer can be crosslinkable either before or after it is shaped into an article.

“Crosslinked,” “cured” and similar terms refer to a polymer that was subjected or exposed to a treatment which induced crosslinking and has xylene or decaline extractables of less than or equal to 90 weight percent (i.e., greater than or equal to 10 weight percent gel content). The polymer can be crosslinked either before or after it is shaped into an article. The phase of the process during which crosslinks are created is termed the “cure phase” and the process of creating crosslinks is termed “curing”.

“Ethylene-based polymer” is a polymer that contains more than 50 weight percent polymerized ethylene monomer (based on the total amount of polymerizable monomers) and, optionally, may contain at least one comonomer. Ethylene-based polymer includes ethylene homopolymer, and ethylene copolymer (meaning units derived from ethylene and one or more comonomers). The terms “ethylene-based polymer” and “polyethylene” may be used interchangeably. Nonlimiting examples of ethylene-based polymer (polyethylene) include low density polyethylene (LDPE) and linear polyethylene. Nonlimiting examples of linear polyethylene include linear low density polyethylene (LLDPE), ultra low density polyethylene (ULDPE), very low density polyethylene (VLDPE), multi-component ethylene-based copolymer (EPE), ethylene/α-olefin multi-block copolymers (also known as olefin block copolymer (OBC)), single-site catalyzed linear low density polyethylene (m-LLDPE), substantially linear, or linear, plastomers/elastomers, and high density polyethylene (HDPE). Generally, polyethylene may be produced in gas-phase, fluidized bed reactors, liquid phase slurry process reactors, or liquid phase solution process reactors, using a heterogeneous catalyst system, such as Ziegler-Natta catalyst, a homogeneous catalyst system, comprising Group 4 transition metals and ligand structures such as metallocene, non-metallocene metal-centered, heteroaryl, heterovalent aryloxyether, phosphinimine, and others. Combinations of heterogeneous and/or homogeneous catalysts also may be used in either single reactor or dual reactor configurations. In an embodiment, the ethylene-based polymer does not contain an aromatic comonomer polymerized therein.

“Ethylenic” and like terms refers to (i) containing ethylene or an ethylene derivative; or (ii) pertaining to or characteristic of ethylene, (e.g. the ethylenic double bond).

“Foamed” and like terms refer to a solid or liquid with many trapped gas bubbles. The gas bubbles trapped in the solid or liquid are typically generated through the use of a foaming agent.

“Grafting conditions” and like terms refer to temperature, pressure, humidity, residence time, agitation, etc., at which a hydrolysable unsaturated silane will graft, i.e., add to or combine with, a polyolefin when the two are contacted with one another. Grafting conditions can vary with the nature of the silane and polyolefin, and the presence or absence of a catalyst.

“Interpolymer” and “copolymer” refer to a polymer prepared by the polymerization of at least two different types of monomers. These generic terms include both classical copolymers, i.e., polymers prepared from two different types of monomers, and polymers prepared from more than two different types of monomers, e.g., terpolymers, tetrapolymers, etc.

“Masterbatch” is a concentrated mixture of a polyolefin resin (e.g., low density polyethylene), a compound with a distinct functional group, and, optionally, additives. The masterbatch can be formed by melt blending the components of the mixture followed by cooling and processing into a granular form.

“Melt blending” is a process in which at least two components are combined or otherwise mixed together, and at least one of the components is in a melted state. The melt blending may be accomplished by one or more of various know processes, e.g., batch mixing, extrusion blending, extrusion molding, and the like. “Melt blended” compositions are compositions which were formed through the process of melt blending.

“Moisture-curable polymer” and like terms refer to a polymer that can be crosslinked upon exposure to moisture. The amount or degree of crosslinking will depend upon, among other things, (1) the curing conditions, e.g., temperature, amount and form of water (bath, mist, etc.), residence time, presence or absence of catalyst and if present, the kind and amount of catalyst, etc., and (2) the moisture-curable polymer itself. In the context of a polyolefin polymer comprising a hydrolyzable silane group, the silane group is first hydrolyzed upon exposure to water in which the hydrolyzable silane group is converted to a silanol group and an alcohol is formed as a by-product. The silanol groups are then crosslinked through a condensation reaction. Typically both the first and second steps are catalyzed with a condensation catalyst.

“Non-foamed” and like terms refer to a solid or liquid with no significant amount of trapped gas bubbles. A non-foamed composition of the present disclosure can be produced in the absence of a foaming agent. In cases where a foaming agent is present, the non-foamed composition is produced under conditions that render the foaming agent inactive. For the purposes of the present disclosure the terms “non-foamed” and “solid” are used interchangeably.

“Olefin-based polymer” or “polyolefin” is a polymer that contains more than 50 weight percent polymerized olefin monomer (based on total amount of polymerizable monomers), and optionally, may contain at least one comonomer. Nonlimiting examples of an olefin-based polymer include ethylene-based polymer and propylene-based polymer. An “olefin” and like terms refers to hydrocarbons consisting of hydrogen and carbon whose molecules contain a pair of carbon atoms linked together by a double bond.

“Pellet” and like terms refer to small particles typically created by compressing a powder or granular material, or by chopping strands created during extrusion of a melt through a die. Pellet shapes and sizes can vary widely.

“Polymer” refers to a compound prepared by reacting (i.e., polymerizing) a set of monomers, wherein the set is a homogenous (i.e., only one type) set of monomers or a heterogeneous (i.e., more than one type) set of monomers. The term polymer as used herein includes the term “homopolymer”, which refers to polymers prepared from a homogenous set of monomers, and the term “interpolymer” as defined below.

“silane-functionalized polyolefin” and like terms refer to an olefin polymer comprising silane functionality.

“Thermoplastic polymer” and like terms refer to a linear or branched polymer that can be repeatedly softened and made flowable when heated and returned to a hard state when cooled to room temperature. The thermoplastic polymer of the present disclosure has an elastic modulus greater than 10,000 psi (68.95 MPa) as measured in accordance with ASTM D638-72. In addition, a thermoplastic polymer can be molded or extruded into an article of any predetermined shape when heated to the softened state.

“Thermoset polymer”, “thermosetting polymers” and like terms indicate that once cured, the polymer cannot be softened nor further shaped by heat. Thermosetting polymers, once cured, are space network polymers and are highly crosslinked to form rigid three-dimensional molecular structures.

“Wire” and like terms refers to a single strand of conductive metal or a single strand of optical fiber.

### Test Methods

Density is measured in accordance with ASTM D792, Method B. The result is recorded in grams (g) per cubic centimeter (g/cc or g/cm³).

Gel content. The gel content test is a measure of the extent of crosslinking within a polymer composition. Gel content typically is proportional to the extent of crosslinking. The extent of crosslinking is measured by dissolving the composition in a solvent for a specified time period and measuring the amount of material that is not extractable. The amount of unextractable material is used to calculate the gel content as a percentage. Gel content is measured by extraction in boiling decalin at 180° C. for 5 hours in accordance with ASTM D2765.

Hot creep test. The hot creep test is performed at 200° C. with a 20 N/cm² weight attached to the lower end of a tape cut out as a dog bone sample with a die cutter in accordance with ASTM D412 type D. The percent elongation of the sample from its initial value is recorded after exposure in the oven for 15 minutes without removing the sample from the oven. Hot creep is tested in accordance to ICEA T-28-562.

Hot deformation. The hot deformation test is conducted in accordance with ASTM D4565. Two duplicate samples of a polymer composition are obtained and preheated at 150° C. in an oven and for 60 min. The pre-heated samples are pressed with a 2 kg weight loading at 150° C. for one hour. The weights remain in place and the pressed samples are placed in a climate controlled room at 23° C. for an additional one hour. The change of the thickness of the samples is recorded and the hot deformation ratio (HD %) is calculated according to:

HD %=(D₀−D₁)/D₀*100%

in which D₀ represents the original sample thickness and D₁ represents the sample thickness after the deformation process. The average of the deformation ratios of the two duplicate samples is reported.

Melt index (MI) measurement for polyethylene is performed according to ASTM D1238, Condition 190° C./2.16 kilogram (kg) weight, formerly known as “Condition E” and also known as I₂, or I2, and is reported in grams eluted per 10 minutes (g/10 min). Melt index is inversely proportional to the molecular weight of the polymer. Thus, the higher the molecular weight, the lower the melt index, although the relationship is not linear.

Surface smoothness test. The surface smoothness of a wire sample is measured in accordance with ANSI 1995 via a SURFTEST™ SJ-400 Surface Texture Measuring Instrument. A wire sample is placed in a V-Block and the stylus (10 urn) is lowered down to a specific start position (about 1 gram force is applied to wire). At a fixed rate of 2 millimeters per second the stylus is moved in the transverse direction taking measurements. Four readings per wire sample and four samples are tested which are then averaged with values reported in micron-inch. Smaller values indicate a higher degree of smoothness. The surface smoothness test conforms to JIS′82, JIS′94, JIS′01, ISO, ANSI, and VDA standards.

Tensile strength and elongation are measured in accordance with ASTM D638. Tensile strength is reported in units of “prig” and elongation is reported as percentage difference between the final length and the initial length of a test specimen.

### DETAILED DESCRIPTION

The present disclosure provides a crosslinked polymeric composition. The crosslinked polymeric composition (interchangeably referred to as “the composition”), includes from 4 wt % to 45 wt % of a thermoplastic polymer, from 52 wt % to 95 wt % of a moisture-curable polyolefin, and from 0.05 wt % to 7 wt % of a moisture condensation catalyst.

### Thermoplastic Polymer

The present composition includes a thermoplastic polymer such as a polyolefin, for example. In an embodiment, the thermoplastic polymer is an ethylene-based polymer. Nonlimiting examples of suitable ethylene-based polymers high density polyethylene (HDPE), medium density polyethylene (MDPE), low density polyethylene (LDPE), linear low density polyethylene (LLDPE), and ethylene/α-olefin copolymer.

In an embodiment, the thermoplastic polymer is an HDPE. “High density polyethylene” or “HDPE,” is an ethylene-based polymer having a density from 0.940, or 0.950, or 0.960 to 0.970, or 0.980 grams per cubic centimeter (g/cm³). The HDPE can include a C₃ to C₂₀ α-olefin comonomer or a C₄ to C₈ α-olefin comonomer. The HDPE has a melt index from 0.5, or 1.0, or 3.0 to 5.0, or 8.0, or 10.0 grams per 10 minutes (g/10 min).

In an embodiment, the thermoplastic polymer is an HDPE that is an ethylene/C₄ to C₈ α-olefin copolymer having one, some, or all of the following properties:

(i) a density from 0.945 g/cm³ to 0.970 g/cm³; and/or

(ii) a melt index from 0.5 g/10 min, or 1.0 g/10 min, or 3.0 g/10 min to 8.0 g/10 min, or 10.0 g/10 min.

The composition includes the thermoplastic polymer in an amount from 4, or 5, or 8, or 10, or 15 to 20, or 25, or 30, or 35, or 40, or 45 wt %. In a further embodiment, the composition includes the thermoplastic polymer in an amount from 4 to 45 wt %, or from 5 to 45 wt %, or from 10 to 35 wt %, or from 15 to 20 wt %. Weight percentage of the thermoplastic polymer is based on the total weight of the composition.

The present disclosure contemplates use of a blend of two or more thermoplastic polymers disclosed herein. The blend may be two or more of the following thermoplastic polymers: HDPE, MDPE, LDPE and/or LLDPE. The blend may be two different HDPEs, for example.

The thermoplastic polymer may comprise two or more embodiments disclosed herein.

### Moisture-Curable Polyolefin

The present composition includes a moisture-curable polyolefin. The moisture-curable polyolefin is a silyl polyolefin. The silyl polyolefin is a polyolefin comprising silane groups. The silane groups can be introduced through copolymerization reactions between an olefin and a silane or by grafting a silane onto a polyolefin as described, for example, in U.S. Pat. Nos. 3,646,155 and 6,048,935.

Grafting of the silane onto the polyolefin can be performed in the presence of a free radical initiator; or alternatively, with ionizing radiation. Nonlimiting examples of free radical initiators include peroxides and azo compounds. Peroxides suitable for use include dicumyl peroxide, di-tert-butyl peroxide, t-butyl perbenzoate, benzoyl peroxide, cumene hydroperoxide, t-butyl peroctoate, methyl ethyl ketone peroxide, 2,5-dimethyl-2,5-di(t-butyl peroxy)hexane, lauryl peroxide, and tert-butyl peracetate. A suitable azo compound is 2,2-azobisisobutyronitrile. In an embodiment, the amount of free radical initiator is from 0.001, or 0.005, or 0.01, or 0.03, or 0.05, or 0.07 to 0.08, or 0.1, or 0.15, or 0.3, or 0.5, or 1, or 1.5, or 2, or 3, or 5 parts per hundred resin (phr). In a further embodiment, the amount of free radical initiator is from 0.001 to 5 phr, or from 0.005 to 1 phr, or from 0.01 to 0.15, or from 0.03 to 0.1 phr. The term “resin” within “parts per hundred resin,” refers to the moisture-curable polyolefin described herein. In an embodiment, the weight ratio of the silane to the initiator is from 10:1, or 18:1 to 250:1, or 500:1. In a further embodiment, the weight ratio of the silane to the initiator is from 10:1 to 500:1, or from 18:1 to 250:1. Grafting of the silane onto the polyolefin can be performed by blending the free radical initiator in the first stage of a reactor extruder, such as a BUSS™ kneader. The melt temperature used during the grafting process can be from 160° C. to 260° C., or from 190° C. to 230° C., depending upon the residence time and the half-life of the free radical initiator.

Silanes suitable for use include unsaturated silanes that comprise (i) an ethylenically unsaturated hydrocarbyl group (e.g., vinyl, allyl, isopropenyl, butenyl, cyclohexenyl or gamma-(meth)acryloxy allyl group); and (ii) a hydrolyzable group (e.g., hydrocarbyloxy group, hydrocarbonyloxy group, or hydrocarbylamino group). Nonlimiting examples of hydrolyzable groups include methoxy, ethoxy, formyloxy, acetoxy, propionyloxy, and alkyl or arylamino groups.

In an embodiment, the silane is an unsaturated alkoxy silane (e.g., vinyl trimethoxy silane, vinyl triethoxy silane, vinyl triacetoxy silane and gamma-(meth)acryloxy propyl trimethoxy silane), such as disclosed along with methods of preparation in U.S. Pat. No. 5,266,627, which is incorporated by reference herein in its entirety.

Nonlimiting examples of silyl polyolefins suitable for use include those having the following formula:

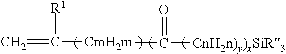

in which R₁ is a hydrogen atom or methyl group; x and y are 0 or 1 with the proviso that when x is 1, y is 1; m and n are independently an integer from 0 to 12 inclusive, preferably 0 to 4, and each R″ independently is a hydrolyzable organic group such as an alkoxy group having from 1 to 12 carbon atoms (e.g., methoxy, ethoxy, butoxy), aryloxy group (e.g., phenoxy), araloxy group (e.g. benzyloxy), aliphatic acyloxy group having from 1 to 12 carbon atoms (e.g., formyloxy, acetyloxy, propanoyloxy), amino or substituted amino groups (e.g., alkylamino, arylamino), or a lower alkyl group having 1 to 6 carbon atoms inclusive, with the proviso that not more than one of the three R groups is an alkyl.

The silyl polyolefin may further comprise heat stabilizers, light stabilizers, and pigments.

Silyl polyolefins suitable for use include SI-LINK™ DFDA-5451 and DFDB-5451, which are copolymers of ethylene and vinyl trimethoxy silane commercially available from The Dow Chemical Company.

In an embodiment, the amount of silicon in the moisture-curable polyolefin is from 0.1, or 0.3, or 0.5, or 0.7, or 1, or 1.5, or 2 to 2.5. or 3, or 3.5, or 5, or 7 or 10, or 20 wt %. In a further embodiment, the amount of silicon in the moisture-curable polyolefin is from 0.1 to 20 wt %, or from 0.3 to 10 wt %, or from 0.7 to 5 wt % or from 0.5 to 3 wt %. The amount of silicon is based on the total weight of the moisture-curable polyolefin.

In an embodiment, the moisture-curable polyolefin has a density from 0.870, or 0.900, or 0.920 to 0.930, or 0.950, or 0.970 g/cm³. In a further embodiment, the moisture-curable polyolefin has a density from 0.870 to 0.970 g/cm³, or from 0.900, or 0.950 g/cm³ or from 0.920 to 0.930 g/cm³. In a particular embodiment, the moisture-curable polyolefin has a density of 0.922 g/cm³.

In an embodiment, the moisture-curable polyolefin has a melt index from 0.3, or 0.5, or 1, or 1.2, or 1.4 to 1.6, or 1.8, or 2, or 4, or 8, or 10, or 50 grams per 10 minutes (g/10 min). In a further embodiment, the moisture-curable polyolefin has a melt index from 0.3 to 50 g/10 min, or from 1.2 to 1.8 g/10 min, or from 1.4 to 1.6 g/10 min. In a particular embodiment, the moisture-curable polyolefin has a melt index of 1.5 g/10 min.

In an embodiment, the moisture-curable polyolefin is a silyl polyolefin that is a copolymer of ethylene and vinyl trimethoxysilane having one, some, or all of the following properties:

(i) a density from 0.920 to 0.930 g/cm³; and/or

(ii) a melt index from 0.5 g/10 min to 2.5 g/10 min.

In an embodiment, the composition includes the moisture-curable polyolefin in an amount from 52, or 53, or 55, or 60 to 70, or 75, or 85, or 90, or 95 wt %. In a further embodiment, the composition includes the moisture-curable polyolefin in an amount from 52 to 95 wt %, or from 55 to 95 wt %, or from 55 to 75 wt %, or from 60 to 70 wt %. Weight percentage of the moisture-curable polyolefin is based on the total weight of the composition.

The moisture-curable polyolefin may comprise two or more embodiments disclosed herein.

### Moisture Condensation Catalyst

The moisture condensation catalyst (alternatively termed a crosslinking catalyst), suitable for use includes Lewis acids, Lewis bases, Brönsted acids, Brönsted bases and combinations thereof. Lewis acids are chemical species that can accept electrons from another chemical species. Lewis bases are chemical species that can donate electrons to another chemical species. Nonlimiting examples of moisture condensation catalysts suitable for use include (i) tin carboxylates such as dibutyl tin dilaurate (DBTDL), dimethyl hydroxy tin oleate, dioctyl tin maleate, di-n-butyl tin maleate, dibutyl tin diacetate, dibutyl tin dioctoate, stannous acetate, stannous octoate; (ii) organo-metal compounds such as lead naphthenate, zinc caprylate and cobalt naphthenate; and (iii) mineral acids such as hydrofluoric acid, hydrochloric acid, hydrobromic acid, hydroiodic acid, nitric acid, phosphoric acid, sulfuric acid, sulfonic acid, boric acid and perchloric acid; and (iv) amines such as primary amines, secondary amines and tertiary amines. In an embodiment, the moisture condensation catalyst is DBTDL or sulfonic acid.

The moisture condensation catalyst is present during the process of melt blending the thermoplastic polymer and moisture-curable polyolefin. In an embodiment, the moisture condensation catalyst can be added to the thermoplastic polymer and/or moisture-curable polyolefin in the form of a masterbatch.

In an embodiment, the moisture condensation catalyst has a density from 0.88, or 0.90, or 0.91, or 0.93, or 0.95 to 0.97, or 0.99, or 1.0, or 1.2, or 1.45 or 1.6 g/cm³. In a further embodiment, the moisture condensation catalyst has a density from 0.88 to 1.6 g/cm³, or from 0.93 to 1.45 g/cm³.

In an embodiment, the moisture condensation catalyst has a melt index from 0.3, or 0.5, or 0.7, or 0.9, or 0.91, or 0.92 to 0.93, or 0.94, or 1, or 2, or 4, or 8, or 10 grams per 10 minutes (g/10 min). In a further embodiment, the moisture condensation catalyst has a melt index from 0.3 to 10 g/10 min, or from 0.9 to 4 g/10 min, or from 0.92 to 0.93 g/10 min.

Moisture condensation catalysts suitable for use include SI-LINK™ DFDA-5481, DFDB-5480, and DFDA-5488, which are masterbatch copolymers commercially available from The Dow Chemical Company.

In an embodiment, the composition includes the moisture condensation catalyst in an amount from 0.05, or 0.1, or 0.5, or 1, or 3, or 4 to 6, or 7 wt %. In a further embodiment, the composition includes the moisture condensation catalyst in an amount from 0.05 to 7 wt %, or from 3 to 7 wt %, or from 4 to 6 wt %. In a particular embodiment, the composition includes 5 wt % of the moisture condensation catalyst. Weight percentage of the moisture condensation catalyst is based on the total weight of the composition.

The moisture condensation catalyst may comprise two or more embodiments disclosed herein.

### Fillers and Additives

The composition of the present disclosure can include an optional filler. In an embodiment, the filler has flame retardant properties. The filler may or may not interact and/or may or may not react with the moisture condensation catalyst. In a further embodiment, the filler is coated with a material (e.g., stearic acid), that will prevent or retard the filler from interfering with the silane/polyolefin crosslinking reaction. Nonlimiting examples of fillers suitable for use include kaolin clay, magnesium hydroxide, silica, calcium carbonate and carbon black, stearic acid and combinations thereof.

The amount of filler in the composition is less than would cause unacceptably large degradation of the mechanical and/or chemical properties of the composition. In an embodiment, the composition includes the filler in an amount from 0.1, or 0.5, or 1, or 2, or 5 to 8, or 10, or 20, or 35 wt %. In a further embodiment, the composition includes the filler in an amount from 0.1 to 35 wt %, or 0.5 to 8 wt %. Weight percentage of the filler is based on the total weight of the composition.

The filler may comprise two or more embodiments disclosed herein.

The composition of the present disclosure can include an optional additive. Nonlimiting examples of fillers suitable for use include antioxidants (e.g., hindered phenols such as IRGANOX™ 1010 available from Ciba Specialty Chemicals); phosphites (e.g., IRGAFOS™ 168 available from Ciba Specialty Chemicals); UV stabilizers; cling additives; light stabilizers (such as hindered amines); plasticizers (such as dioctylphthalate or epoxidized soy bean oil); metal deactivators; scorch inhibitors; mold release agents; tackifiers (such as hydrocarbon tackifiers); waxes (such as polyethylene waxes); nucleating agents; processing aids (such as oils, organic acids such as stearic acid, metal salts of organic acids); oil extenders (such as paraffin oil and mineral oil); colorants; and pigments. Moisture generators can accelerate the cure phase of the process during which crosslinks are created.

The composition of the present disclosure excludes the use of a foaming agent. In other words, the present composition is a non-foamed composition.

The amount of additive in the composition is less than would interfere with desired physical or mechanical properties of the composition and is determined by the skilled artisan. In an embodiment, the composition includes the additive in an amount from 0.1, or 0.5, or 1, or 2, or 5 to 8, or 10, or 20, or 35 wt %. In a further embodiment, the composition includes the additive in an amount from 0.1 to 35 wt %, or from 0.5 to 8 wt %. Weight percentage of the additive is based on the total weight of the composition.

The additive may comprise two or more embodiments disclosed herein.

### Composition

In an embodiment, the composition has a sum weight of the thermoplastic polymer (TP) and the moisture-curable polyolefin (MCP) of 80, or 85, or 90, or 91, or 92, or 93, or 94 to 95, or 96, or 97, or 98 wt %. In a further embodiment, the composition has a sum weight of the TP and the MCP from 80 to 98 wt %, or from 90 to 97 wt %, or from 94 to 96 wt %. In a particular embodiment, the composition has a sum weight of the TP and the MCP of 95 wt %.

In an embodiment, the composition has a sum weight of the moisture-curable polyolefin (MCP) and the moisture condensation catalyst (MCC) of 50, or 60, or 70, or 75, or 80, or 85, or 90 to 95, or 97, or 98 wt %. In a further embodiment, the composition has a sum weight of the MCP and the MCC from 50 to 98 wt %, or from 60 to 95 wt %, or from 85 to 95 wt %.

In an embodiment, the composition comprises a weight ratio of the MCP to the TP from 1, or 1.4, or 2, or 3, or 3.8, or 4.5, or 5, or 5.3, or 7 to 8, or 8.5, or 9, or 15, or 18, or 20. In a further embodiment, the composition comprises a weight ratio of the MCP to the TP from 1 to 20, or from 3 to 18, or from 5 to 9.

In an embodiment, the composition comprises a weight ratio of the MCP to the MCC from 5, or 10, or 11, or 13, or 15, or 16 to 17, or 18, or 19, or 20, or 30. In a further embodiment, the composition comprises a weight ratio of the MCP to the MCC from 5 to 30, or from 10 to 20, or from 15 to 18.

In an embodiment, the composition comprises a weight ratio of the TP to the MCC from 0.5, or 1, or 2, or 3, or 4 to 5, or 6, or 7, or 8, or 10, or 20, or 30. In a further embodiment, the composition comprises a weight ratio of the TP to the MCC from 0.5 to 30, or from 1 to 10, or from 3 to 8.

Weight percentage of the additive is based on the total weight of the composition.

The composition of the present disclosure includes a polymeric component that comprises the thermoplastic polymer and the moisture-curable polyolefin. In an embodiment, the polymeric component is a crosslinked form of the thermoplastic polymer and the moisture-curable polyolefin. Not wishing to be limited by theory, crosslinking within the polymeric component can provide temperature resistance to the polymeric component, as well as to the composition comprising the polymeric component. Temperature resistance is quantified by measurement of the hot creep and hot deformation properties of the composition.

The extent of crosslinking within the polymeric component is correlated to the gel content of the composition, i.e., the extent of crosslinking is proportional to gel content. Alternatively, the extent of crosslinking within the polymeric component can be correlated to the hot creep value of the composition, the hot deformation value of the composition or a combination thereof. In an embodiment, the polymeric component is crosslinked as indicated by a gel content from 60%, or 65% to 70%, or 75%, or 80% as disclosed herein. In a further embodiment, the polymeric component is crosslinked as indicated by a hot creep value from 10%, or 20% to 30%, or 45% as disclosed herein. In a still further embodiment, the polymeric component is crosslinked as indicated by a hot deformation value from 7% to 36%, as disclosed herein.

In an embodiment, the polymeric component is crosslinked when the thermoplastic polymer is present in an amount from 5 to 40 wt %, the moisture-curable polyolefin is present in an amount from 55 to 90 wt %, and the moisture condensation catalyst is present in an amount from 3 to 7 wt %, wherein weight percentages are based on the total weight of the composition.

In an embodiment, the composition of the present disclosure is a non-foamed composition.

In an embodiment, the composition of the present disclosure is a thermoset composition.

In an embodiment, the composition of the present disclosure is void of monomer units derived from propylene.

In an embodiment, the composition has a surface smoothness from 3, or 13, or 25, or 51, or 89, or 102, or 114, to 127, or 140, or 149, or 152, or 162, or 178, or 184, or 191, or 203, or 216, or 229, or 254 μ·in. In a further embodiment, the composition has a surface smoothness from 3 to 254 μ·cm (1 to 100 μ·in), or from 51 to 229 μ·cm (20 to 90 μ·in), or from 89 to 216 μ·cm (35 to 85 μ·in), or from 89 to 191 μ·cm (35 to 75 μ·in), or from 102 to 184 μ·cm (40 to 72 μ·in), or from to 102 to 162 μ·cm (40 to 64 μ·in), or from 102 to 127 μ·cm (40 to 50 μ·in).

In an embodiment, the composition has a hot creep value from 1%, or 5%, or 10%, or 15%, or 20% to 25%, or 30%, or 35%, or 40%, or 45%. In a further embodiment, the composition has a hot creep value from 1% to 45%, or from 5% to 43%, or from 10% to 41%, or from 10% to 35%, or from 10% to 30%, or from 10% to 25%.

In an embodiment, the composition has a hot deformation value from 1%, or 5%, or 7%, or 10%, or 15%, or 20% to 25%, or 30%, or 36%. In a further embodiment, the composition has a hot deformation creep value from 1% to 55%, or from 5% to 40%, or from 7% to 36%, or from 10% to 25%.

In an embodiment, the composition has a gel content from 60%, or 65% to 70%, or 75%, or 80%. In a further embodiment, the composition has a gel content from 60% to 80%, or from 65% to 75%.

### Compounding and Fabrication

Melt blending of the thermoplastic polymer, moisture-curable polyolefin, moisture condensation catalyst, and optional filler and additives are performed by standard methods known to those skilled in the art. Examples of compounding equipment include BRABENDER™, BANBURY™ and BOLLING™ internal batch mixers. Continuous single or twin screw mixer or extruders suitable for use include DAVIS STANDARD™ extruders, FARREL™ continuous mixes, WERNER AND PFLEIDERER™ twin screw mixers, and BUSS™ kneading continuous extruders. The type of mixer utilized, and the operating conditions of the mixer, will affect properties of the composition such as viscosity, volume resistivity, and extruded surface smoothness.

The components of the composition are typically mixed at a temperature and for a length of time sufficient to fully homogenize the mixture but insufficient to cause the material to gel. The moisture condensation catalyst can be added to the moisture-curable polyolefin directly; or alternatively, added before, with or after the optional filler and additives are added to the moisture-curable polyolefin. Typically, the components are mixed together in a melt-mixing device. The mixture is then shaped into the final article. The temperature of compounding and article fabrication should be above the melting point of the moisture-curable polyolefin but preferably below 250° C.

In an embodiment, the moisture-curable polyolefin, the moisture condensation catalyst, the filler, the additive and combinations thereof are added in the form of a masterbatch.

In one embodiment, one or more of the components are dried before compounding, or a mixture of components is dried after compounding, to reduce or eliminate potential scorch that may be caused from moisture present in or associated with the component, e.g., filler.

In an embodiment, the polymeric composition is non-foamed and includes:

(A) from 5 wt % to 40 wt % HDPE;

(B) from 55 wt % to 90 wt % of an ethylene and vinyltrimethoxysilane copolymer; and

(C) from 0.05 wt % to 7 wt % of a dibutyl tin dilaurate moisture condensation catalyst;
The polymeric composition having one, some, or all of the following properties:
(i) a gel content from 60% to 80%; and/or
(ii) a hot creep value from 10% to 45%; and/or
(ii) a hot deformation value from 7% to 36% (hereafter referred to as polymeric composition 1).

### Articles of Manufacture

In one embodiment, the composition of the present disclosure is applied to a conductor as a coating in known amounts and by known methods (for example, with the equipment and methods described in U.S. Pat. Nos. 5,246,783 and 4,144,202). Typically, the composition is prepared in a reactor-extruder equipped with a conductor-coating die and after the components of the composition are formulated, the composition is extruded over the conductor as the conductor is drawn through the die. The composition can be extruded over the conductor at a line speed from 800 to 2000 feet per minute (from 243 to 610 meters per minute, m/min). The cure phase of the process, during which crosslinks are created, may begin in the reactor-extruder. The shaped article can be exposed to either or both elevated temperature and external moisture and if an elevated temperature, it is typically between ambient and up to but below the melting point of the composition for a period of time such that the article reaches a desired degree of crosslinking. The temperature of any post-shaping cure should be above 0° C.

In an embodiment, the coating is an insulation layer in direct contact with the conductor. The term “in direct contact,” as used herein indicates that the conductor and the insulation layer are in an adhering relationship to one another such that the conductor is located immediately adjacent to the insulation layer and no intervening structure is present between the two.

In a particular embodiment, the insulation layer is used for twisted-pair category data cables. The insulation layer is suitable for all category data cable ratings including Cat2, Cat3, Cat4, Cat5, Cat5e, Cat6, Cat6a and Cat7. The category data cable can carry low voltage power that serves as a power source for electronic devices. Combined power and data cable applications are termed “Power over Ethernet” or “PoE.”

In an embodiment, the insulation layer has a thickness from 127 μm (5 Mil), or 178 μm (7 Mil), or 229 μm (9 Mil), or 254 μm (10 Mil), or 305 μm (12 Mil) to 381 μm (15 Mil), or 451 μm (18 Mil), or 508 μm (205 Mil). In a further embodiment, the insulation layer has a thickness from 127 μm (5 Mil) to 508 μm (205 Mil), or from 178 μm (7 Mil) to 381 μm (15 Mil), or from 229 μm (9 Mil) to 305 μm (12 Mil).

In an embodiment, the insulation layer is a non-foamed insulation layer.

In an embodiment, a coated conductor is provided and includes a conductor, and a coating on the conductor. The coating is a non-foamed polymeric composition composed of polymeric composition 1:
(A) from 5 wt % to 40 wt % HDPE;
(B) from 55 wt % to 90 wt % of an ethylene and vinyltrimethoxysilane copolymer; and
(C) from 0.5 wt % to 7 wt % of a dibutyl tin dilaurate moisture condensation catalyst;
the coating having one, some, or all of the following properties:
   (i) a surface smoothness from 102 μ·cm to 184 μ·cm; and/or
   (ii) a tensile strength from 1905 psig to 2410 psig; and/or
   (iii) a elongation from 215% to 265%.

Other articles of manufacture that can be prepared from the composition of the present disclosure include fibers, ribbons, sheets, tapes, tubes, pipes, weather-stripping, seals, gaskets, hoses, footwear and bellows. These articles can be manufactured using known equipment and techniques.

The present disclosure is described more fully through the following examples. Unless otherwise noted, all parts and percentages are by weight.

### EXAMPLES

The raw materials for use in the Inventive Examples (“IE”) and Comparative Samples (“CS”) are detailed in Table 1 below.

TABLE 1

| Commercial Name | Composition & Properties | Source |
|---|---|---|
| AXELERON ™ | High density polyethylene (HDPE) | The Dow |
| CS L-3364 NT | Density: 0.945 g/cm³ | Chemical |
| | Melt Index: 0.7 g/10 min | Company |
| AXELERON ™ | High density polyethylene (HDPE) | The Dow |
| 6944 NT | Density: 0.965 g/cm³ | Chemical |
| | Melt Index: 8 g/10 min | Company |
| SI-LINK ™ | Ethylene/vinyl trimethoxy silane | The Dow |
| DFDB-5451 NT | copolymer with scorch retardant | Chemical |
| | Density: 0.922 g/cm³ | Company |
| | Melt index: 1.5 g/10 min @ | |
| | 190° C./2.16 kg | |
| SI-LINK ™ | LDPE masterbatch containing | The Dow |
| DFDA-5481 NT | dibutyl tin dilaurate | Chemical |
| | Density: 0.93 g/cm³ | Company |
| | Melt index: 0.925 g/10 min @ | |
| | 190° C./2.16 kg | |
| SI-LINK ™ | LDPE masterbatch containing | The Dow |
| DFDA-5488 NT | sulfonic acid | Chemical |
| | Density: 1.45 g/cm³ | Company |
| | Melt index: 0.925 g/10 min @ | |
| | 190° C./2.16 kg | |

Polymeric compositions for Inventive Examples IE-1, IE-2, IE-3, IE-4, IE-5 and Comparative Samples CS-1 & CS-2 are prepared for coated conductor samples according to the formulations listed in Table 2 with the raw materials listed in Table 1.

Coated conductor samples are prepared from tinned, 7 strand, 24 American Wire Gauge (AWG) core. A composition of the components is first dry blended. The composition is then melt blended by extrusion blending with a 2.5 inch DAVIS STANDARD extruder having 22:1 LID and fitted with a PE screw having a dual flight mixing section. The melt blended composition is extruded over the conductor as the conductor is drawn through the extruder die at a line speed of 548 meters per minute. The temperature profile of the extruder is 150° C. to 182° C. across four zones. The extruded coated conductor is cured in a 90° C. water bath for 14-18 hours and then dried in a convection oven overnight at 80° C., or cured in a humidity chamber at 50° C. and 75% relative humidity for 14 days and then dried overnight at 80° C.

The thickness of the coated conductor is 254 μm (10 Mil).

Polymeric compositions for Inventive Examples IE-7, IE-8, IE-9, IE-10, IE-11 and Comparative Samples CS-3, CS-4, CS-5 & CS-6 are prepared for tape samples according to the formulations listed in Table 2 with the raw materials listed in Table 1.

Tape samples are prepared by first dry blending a composition of the components. The composition is then melt blended by extrusion blending into 2 inch tape with a ¾ inch single screw BRABENDER™ batch mixer having 25:1 LID and fitted with a Maddox mixing screw. The melt blended composition is extruded at 50 revolutions per minute (rpm) and a take-up speed of 38 feet per minute. The temperature profile of the extruder is from 150° C. to 182° C. across all five zones. The extruded tape is cured in a 90° C. water bath for 14-18 hours and then dried in a convection oven overnight at 80° C., or cured in a humidity chamber at 50° C. and 75% relative humidity for 14 days and then dried overnight at 80° C.

The test results formulations for the Inventive Examples and Comparative Samples are reported in Table 2 below.

TABLE 2

| | Coated Conductor Weight Percentage | | | | | | | Tape Sample Weight Percentage |
|---|---|---|---|---|---|---|---|---|
| | CS-1 | CS-2 | IE-1 | IE-2 | IE-3 | IE-4 | IE-5 | CS-3 |
| L-3364 | 100 | | 5 | 10 | 15 | 20 | 40 | |
| DFDB-5451 | | 95 | 90 | 85 | 80 | 75 | 55 | |
| DFDA-5481 | | 5 | 5 | 5 | 5 | 5 | 5 | |
| 6944 NT | | | | | | | | 100 |
| DFDA-5488 | | | | | | | | |
| Total | 100 | 100 | 100 | 100 | 100 | 100 | 100 | 100 |
| Surface | NT* | 229 | 184 | 162 | 149 | 127 | 102 | |
| Smoothness | | | | | | | | |
| (μ-cm) | | | | | | | | |
| Hot Creep | broke/ | 24.98 | 28.87 | 26.71 | 26.5 | 28.24 | 33.03 | |
| (%) | fail | | | | | | | |
| Tensile | NT* | 1822.2 | 1905.2 | 2087.8 | 2175 | 2187.4 | 2405.2 | |
| Strength | | | | | | | | |
| (psig) | | | | | | | | |
| Elongation | NT* | 213.2 | 218 | 238.2 | 241.4 | 226.6 | 261.4 | |
| (%) | | | | | | | | |
| Line speed | 548 | 548 | 548 | 548 | 548 | 548 | 548 | |
| (m/min) | | | | | | | | |
| Hot Creep | | | | | | | | Fail |
| (%) | | | | | | | | |
| Hot | | | | | | | | 100 |
| Deformation | | | | | | | | |
| at 150° C. | | | | | | | | |
| (%) | | | | | | | | |
| Gel Content | | | | | | | | 0.92 |
| (%) | | | | | | | | |

| | Tape Sample Weight Percentage | | | | | | | |
|---|---|---|---|---|---|---|---|---|
| | CS-4 | CS-5 | CS-6 | IE-7 | IE-8 | IE-9 | IE-10 | IE-11 |
| L-3364 | 100 | | | 5 | 10 | 20 | 40 | 20 |
| DFDB-5451 | | 95 | 95 | 90 | 85 | 75 | 55 | 75 |
| DFDA-5481 | | 5 | | 5 | 5 | 5 | 5 | |
| 6944 NT | | | | | | | | |
| DFDA-5488 | | | 5 | | | | | 5 |
| Total | 100 | 100 | 100 | 100 | 100 | 100 | 100 | 100 |
| Surface | | | | | | | | |
| Smoothness | | | | | | | | |
| (μ-cm) | | | | | | | | |
| Hot Creep | | | | | | | | |
| (%) | | | | | | | | |
| Tensile | | | | | | | | |
| Strength | | | | | | | | |
| (psig) | | | | | | | | |
| Elongation | | | | | | | | |
| (%) | | | | | | | | |
| Line speed | | | | | | | | |
| (m/min) | | | | | | | | |
| Hot Creep | Fail | 9.9 | 15.3 | 11.1 | 10.5 | 15.9 | 40.4 | 27.3 |
| (%) | | | | | | | | |
| Hot | 100 | 7.3 | −0.1 | 6.6 | 11.2 | 10.6 | 35.7 | 9.2 |
| Deformation | | | | | | | | |
| at 150° C. | | | | | | | | |
| (%) | | | | | | | | |
| Gel Content | 1.47 | 51.16 | 82.28 | 79.45 | 74.46 | 65.41 | 59.12 | 64.92 |
| (%) | | | | | | | | |

*NT: Not tested

### Results and Discussion

CS-1 and CS-2 are coated conductors. CS-1 is wire coated with HDPE having no crosslinking that fails the hot creep test. CS-2 is wire coated with a crosslinked polymer containing no thermoplastic component. CS-2 has the least favorable results for surface smoothness and tensile properties of all the coated conductors investigated.

CS-3 through CS-6 are tape samples. CS-3 and CS-4 are HDPE thermoplastic compounds with no crosslinking. CS-3 and CS-4 each exhibit poor tensile properties: hot creep value of 100% and failure of the hot deformation test. The CS-5 tape sample has no thermoplastic component and exhibits the lowest extent of crosslinking, (gel content of 51%), of all tape samples investigated. CS-6 is an acid-catalyzed crosslinked composition containing no thermoplastic compound. The CS-6 tape sample swells during the hot deformation test as indicated by the negative result posted. CS-6 has extensive crosslinking as indicated by a gel content of 82%.

Applicant discovered non-foamed, insulative compositions of a thermoplastic polymer and a moisture-curable polyolefin that are crosslinked as indicated by a gel content percentage from 60 to 82.

The inventive compositions (IE-1 to IE-5), unexpectedly provide insulated coated conductor articles having: (i) surface smoothness from 102 to 184 μ·cm (40 to 72 μ·in) that is from 44% to 80% improved over crosslinked compositions containing no thermoplastic polymer; (ii) hot creep percentage from 26.5 to 33.0 that is from 8% to 30% improved over crosslinked compositions containing no thermoplastic polymer; and (iii) tensile strength from 1905 to 2410 prig that is from 5% to 132% improved over crosslinked compositions containing no thermoplastic polymer.

The inventive compositions (IE-7 to IE-11), unexpectedly provide tape articles having: (i) hot creep percentage from 11.1 to 40.4 that is from 12% to 308% improved over crosslinked compositions containing no thermoplastic polymer; and (ii) hot deformation percentage from 9.2 to 35.7 that is from 26% to 390% improved over crosslinked compositions containing no thermoplastic polymer.

It is specifically intended that the present disclosure not be limited to the embodiments and illustrations contained herein, but include modified forms of those embodiments including portions of the embodiments and combinations of elements of different embodiments as come with the scope of the following claims.

1. A crosslinked polymeric composition comprising:
(A) from 4 wt % to 45 wt % of a thermoplastic polymer;
(B) from 52 wt % to 95 wt % of a moisture-curable polyolefin; and
(C) from 0.05 wt % to 7 wt % of a moisture condensation catalyst.

2. The composition of claim 1 wherein the thermoplastic polymer comprises high density polyethylene.

3. The composition of claim 2 wherein the high density polyethylene has a density from 0.945 g/cm3 to 0.970 g/cm3 and a melt index from 0.5 g/10 min to 10 g/10 min.

4. The composition of claim 1 wherein the moisture-curable polyolefin has a density from 0.920 g/cm3 to 0.930 g/cm3 and a melt index from 0.5 g/10 min to 2.5 g/10 min.

5. The composition of claim 1 wherein the polymeric composition has a gel content from 60% to 80%.

6. The composition of claim 5 wherein the polymeric composition has a hot creep value from 10% to 45%.

7. The composition of claim 1 wherein the polymeric composition has a hot deformation value at 150° C. from 7% to 36%.

8. (canceled)

9. The composition of claim 3 comprising:
from 5 wt % to 40 wt % of high density polyethylene;
from 55 wt % to 90 wt % of the moisture-curable polyolefin;
from 3 wt % to 7 wt % of the moisture condensation catalyst;
a gel content from 60% to 80%;
a hot creep value from 10% to 40%; and
a hot deformation value from 7% to 36%.

10. (canceled)

11. (canceled)

12. (canceled)

13. A coated conductor comprising:
a conductor; and
a coating on the conductor, the coating comprising the crosslinked polymeric composition of claim 1.

14. (canceled)

15. The coated conductor of claim 9 comprising:
a surface smoothness from 102 μ·cm to 184 μ·cm;
a hot creep value from 10% to 40%; and
a hot deformation value at 150° C. from 7% to 36%.
